(19) United States
(12) Patent Application Publication
(10) Pub. No.: US 2013/0021744 A1
(43) Pub. Date: Jan. 24, 2013

(54) DUMMY HARD DISK DRIVE

(71) Applicant: ZHENG-HENG SUN, Tu-Cheng, New Taipei (TW)

(72) Inventor: ZHENG-HENG SUN, Tu-Cheng, New Taipei (TW)

(73) Assignee: HON HAI PRECISION INDUSTRY CO., LTD., Tu-Cheng (TW)

(21) Appl. No.: 13/221,857

(22) Filed: Aug. 30, 2011

(30) Foreign Application Priority Data
Jul. 20, 2011 (CN) 201110203612.7

(51) Int. Cl. G06F 1/16

(52) U.S. Cl. 361/679.33; 428/12

(57) ABSTRACT

A dummy hard disk drive (HDD) is arranged in an electronic device. The dummy HDD includes a first plate, a second plate, a third plate, and a fourth plate. The first plate, the second plate, the third plate, and the fourth plate are head-to-tail connected to form a quadrangle-shaped frame. The frame is foldable by rotating the first to fourth plates.

### BACKGROUND

1. Technical Field

The present disclosure relates to a dummy hard disk drive (HDD) for an electronic device.

2. Description of Related Art

An electronic device, such as a computer or a server, usually includes a plurality of brackets for mounting HDDs. A dummy HDD is usually received and filled in each bracket to avoid the bracket from being deformed or damaged when manufacturing or transporting these brackets. When a true HDD is received in the bracket, the dummy HDD will be moved out. However, a traditional dummy HDD is often fixed in its structure, and not foldable, which causes space waste when the dummy HDD is boxed and transported.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an embodiment of an assembled dummy hard disk drive (HDD).

FIG. 2 is an exploded, isometric view of FIG. 1.

FIG. 3 is an enlarged view of the circled portion III of FIG. 2.

FIG. 4 is an enlarged view of the circled portion IV of FIG. 2.

FIGS. 5 and 6 show different states of use of the dummy HDD of FIG. 1.

FIG. 7 is a state of use when the dummy HDD is mounted to an electronic device.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

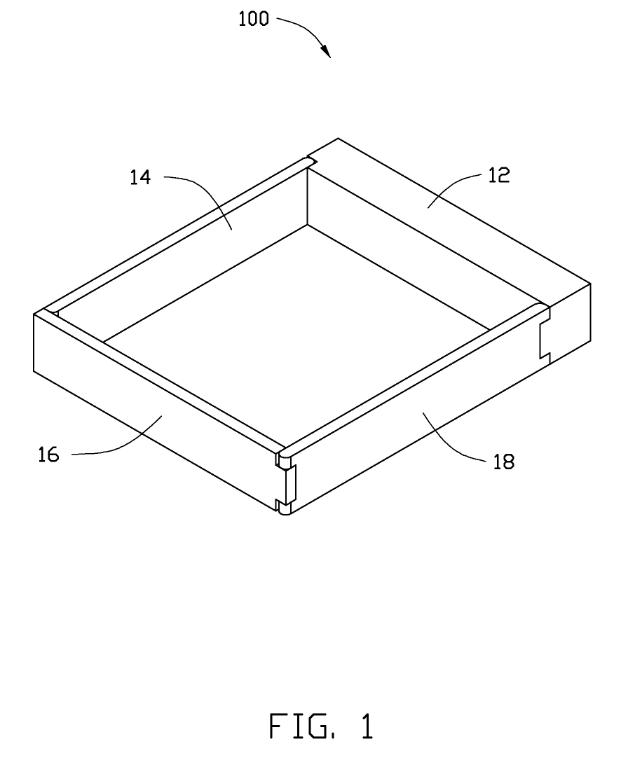

Referring to FIG. 1, an embodiment of a dummy hard disk drive (HDD) 100 includes a first plate 12, a second plate 14, a third plate 16, and a fourth plate 18. The first to fourth plates 12, 14, 16, 18 are made of resilient material, such as rubber and plastic.

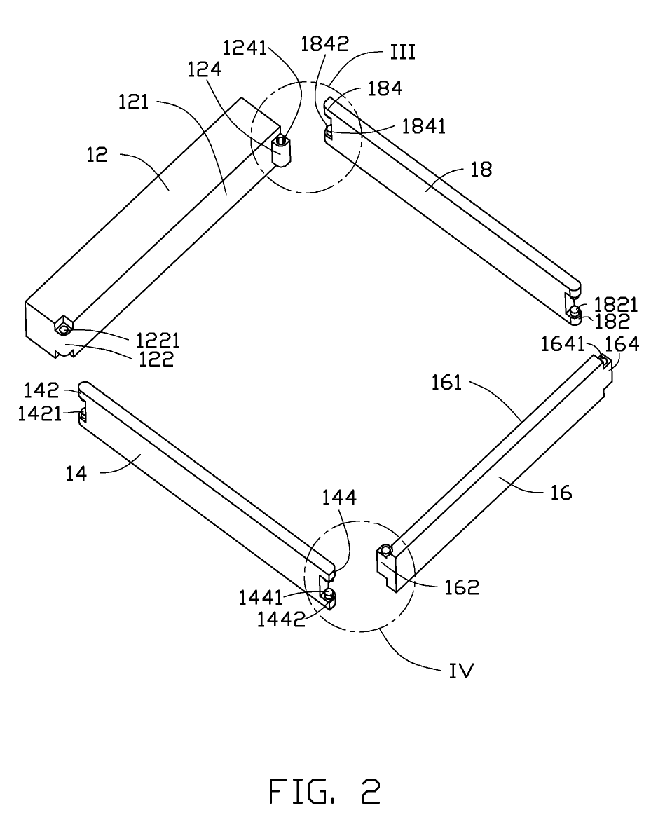

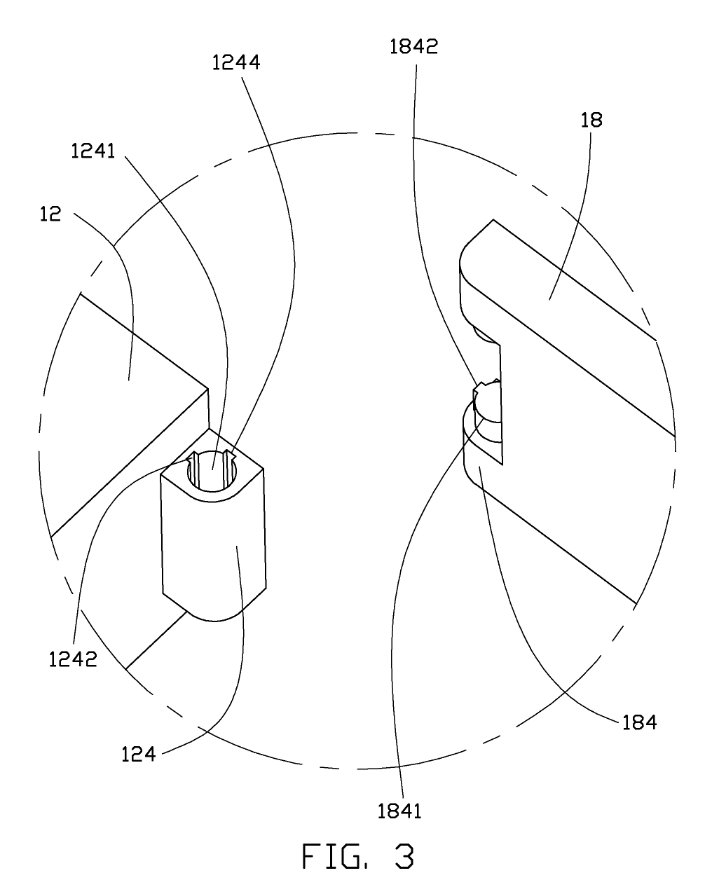

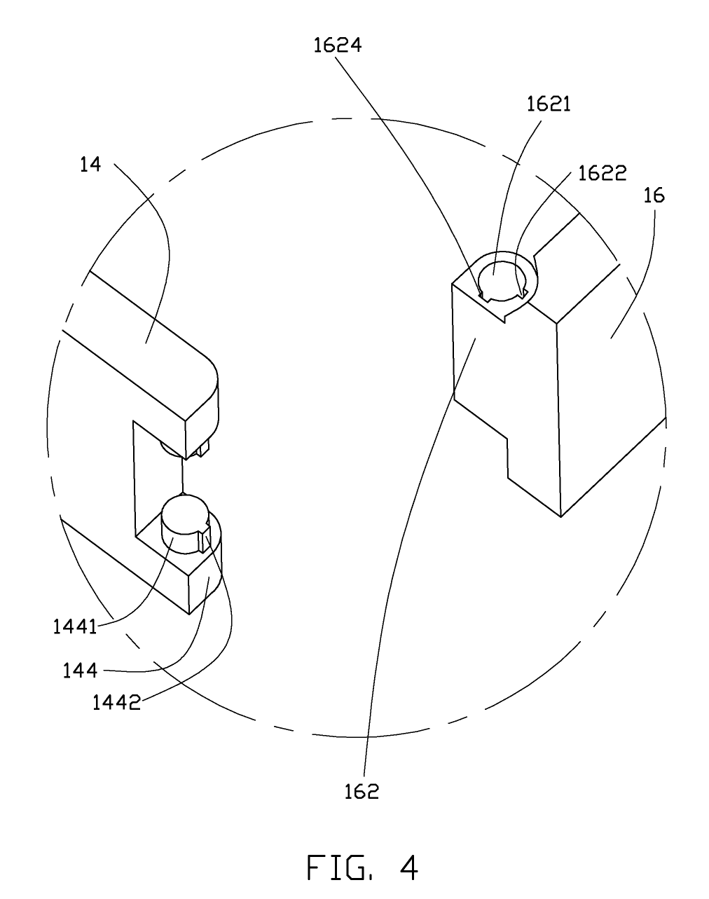

Referring to FIGS. 2-4, a first pivot portion 122 is formed on a first end of an inner surface 121 of the first plate 12. A pivot hole 1221 is defined in the first pivot portion 122. A second pivot portion 124 protrudes inwards from the inner surface 121 of a second end of the first plate 12. A pivot hole 1241 is defined in the second pivot portion 124. A first positioning slot 1242 and a second positioning slot 1244 are defined in the inner surface bounding the pivot hole 1241. The first positioning slot 1242 is angled about 90 degrees from the second positioning slot 1244, the first positioning slot 1242 and the second positioning slot 1244 are intended to act as an anti-rotation arrangement.

The second plate 14 includes a first connecting portion 142 and a second connecting portion 144 formed on opposite ends of the second plate 14. The first connecting portion 142 includes two flexile pins 1421 formed thereon and toward each other. The second connecting portion 144 includes two flexile pins 1441 formed thereon and toward each other. Each pin 1441 forms a flexile raised portion 1442 on the circumference of the pin 1441, to be engaged in the slots 1242 and 1244, and which (in conjunction with the slots 1242 and 1244) completes the anti-rotation arrangement mentioned above.

The third plate 16 includes an inner surface 161. A first pivot portion 162 is formed on a first end of the inner surface 161 of the third plate 16. A pivot hole 1621 is defined in the first pivot portion 162. A first positioning slot 1622 and a second positioning slot 1624 are defined in the inner surface bounding the pivot hole 1621. The first positioning slot 1622 is angled about 90 degrees from the second positioning slot 1624. A second pivot portion 164 protrudes from a second end of the third plate 16. A pivot hole 1641 is defined in the second pivot portion 164.

The fourth plate 18 is the same as the second plate 14. The fourth plate 18 includes a first connecting portion 182 and a second connecting portion 184 formed on opposite ends of the fourth plate 18. The first connecting portion 182 includes two flexile pins 1821 formed thereon and toward each other. The second connecting portion 184 includes two flexile pins 1841 formed thereon and toward each other. Each pin 1841 forms a flexile raised portion 1842 on the circumference of the pin 1841.

Referring to FIG. 1, in assembly, the first to fourth plates 12, 14, 16, and 18 are head-to-tailconnected head-to-tail to form a square frame. The size and shape of the frame are the same as an actual HDD, thereby forming the dummy HDD 100. The pins 1421 are pivotably engaged in the pivot hole 1221, from the top and the bottom of the first connecting portion 122. The pins 1441 are pivotably engaged in the pivot hole 1621, from the top and the bottom of the first pivot portion 162. The pins 1821 are pivotably engaged in the pivot hole 1641, from the top and the bottom of the second pivot portion 164. The pins 1841 are pivotably engaged in the pivot hole 1241, from the top and the bottom of the second pivot portion 124.

In a first state of use as shown in FIG. 1, the raised portion 1842 is engaged in the first positioning slot 1242 to position the first plate 12 perpendicular to the fourth plate 18. The raised portion 1442 is engaged in the first positioning slot 1622 to position the second plate 14 perpendicular to the third plate 16. Thus the dummy HDD 100 becomes a rectangular frame.

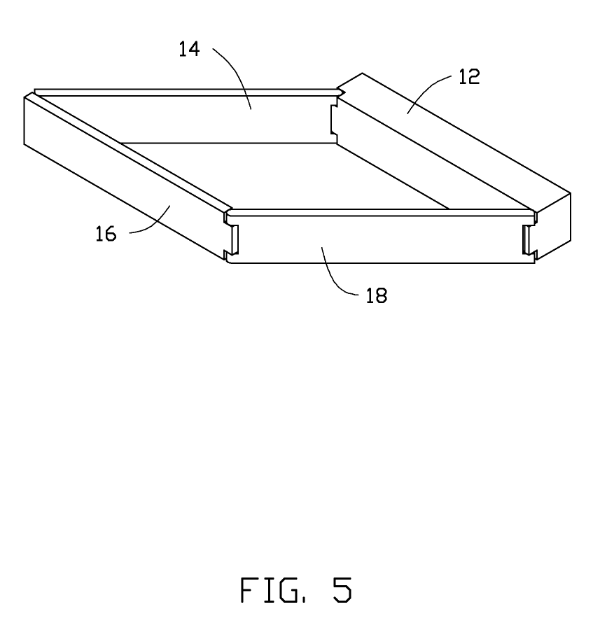

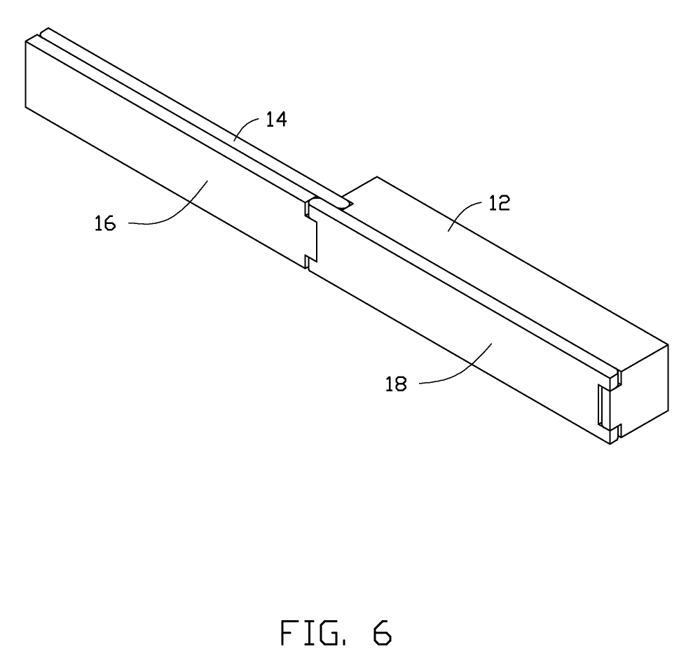

Referring to FIG. 5 and FIG. 6, rotating the second plate 14 and the fourth plate 18 relative to the first plate 12, the dummy HDD 100 first assumes a rhomboidal shape. The fourth plate 18 and the third plate 16 are kept close to the first plate 12 and the second plate 14, respectively. In the second state of use as shown in FIG. 6, the raised portion 1842 is engaged in the second positioning slot 1244 to position the first plate 12 parallel to the fourth plate 18. The raised portion 1442 is engaged in the second positioning slot 1624 to position the second plate 14 parallel to the third plate 16. Thus the dummy HDD 100 is folded.

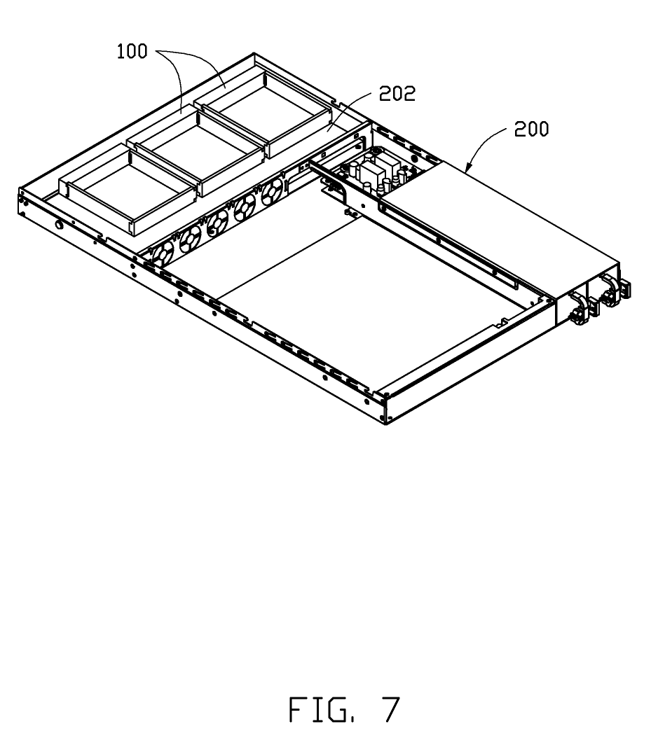

Referring to FIG. 7, an electronic device 200 defines an HDD receiving area 202. At least one dummy HDD 100 may be arranged in the HDD receiving area 202, to replace or be substituted by at least one true HDD.

In this embodiment, the first to fourth plates 12, 14, 16, and 18 are connected head-to-tail to form the dummy HDD 100. When the dummy HDD 100 needs to be arranged in the electronic device 200, the dummy HDD 100 maintains a rectangular shape. When not in use, the dummy HDD 100 can be folded for easy packing and transporting.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A dummy hard disk drive (HDD) for being arranged in an electronic device, comprising:
a first plate;
a second plate;
a third plate; and
a fourth plate, wherein the first plate, the second plate, the third plate, and the fourth plate are pivotably head-to-tail connected to form a rectangular frame, thereby the frame is foldable by rotating the first to fourth plates.

2. The dummy HDD of claim 1, wherein the first plate comprises a first pivot portion formed on an inner surface of a first end of the first plate, a first pivot hole is defined in the first pivot portion, a first connecting portion is formed at a first end of the second plate, the first connecting portion comprises two first pins pivotably engaging in the first pivot hole.

3. The dummy HDD of claim 2, wherein a second pivot portion is formed on an inner surface of a first end of the third plate, a second pivot hole is defined in the second pivot portion, a second connecting portion is formed at a second end of the second plate, the second connecting portion comprises two second pins pivotably engaging in the second pivot hole.

4. The dummy HDD of claim 3, wherein a third pivot portion is formed at a second end of the third plate, the third pivot portion defines a third pivot hole, a third connecting portion is formed at a first end of the fourth plate, the third connecting portion comprises two third pins pivotably engaging in the third pivot hole.

5. The dummy HDD of claim 4, wherein a fourth pivot portion is formed on the inner surface of a second end of the first plate, the fourth pivot portion defines a fourth pivot hole, a fourth connecting portion is formed at a second end of the fourth plate, the fourth connecting portion comprises two fourth pins pivotably engaging in the fourth pivot hole.

6. The dummy HDD of claim 5, wherein an inner wall bounding the fourth pivot hole of the fourth pivot portion of the first plate defines a first positioning slot, and a second positioning slot angled about 90 degrees from the first positioning slot, a first raised portion extends on a circumference of one of the fourth pins of the fourth connecting portion of the fourth plate, the first raised portion of the fourth plate is engaged in either the first positioning slot or the second positioning slot of the first plate.

7. The dummy HDD of claim 6, wherein an inner wall bounding the second pivot hole of the second pivot portion of the third plate defines a third positioning slot, and a fourth positioning slot angled about 90 degrees from the third positioning slot, a second raised portion extends on a circumference of one of the second pins of the second connecting portion of the second plate, the second raised portion of the second plate is engaged in either the third positioning slot or the fourth positioning slot of the third plate.

8. An electronic device comprising:
a hard disk drive receiving area; and
at least one dummy hard disk drive (HDD) arranged in the hard disk drive receiving area, wherein the dummy HDD is operable to be folded.

9. The electronic device of claim 8, wherein the dummy HDD comprises a first plate, a second plate, a third plate, and a fourth plate, wherein the first plate, the second plate, the third plate, and the fourth plate are head-to-tail connected to form a quadrangle-shaped frame.

10. The electronic device of claim 9, wherein the first plate comprises a first pivot portion formed on an inner surface of a first end of the first plate, a first pivot hole is defined in the first pivot portion, a first connecting portion is formed at a first end of the second plate, the first connecting portion comprises two first pins pivotably engaging in the first pivot hole.

11. The electronic device of claim 10, wherein a second pivot portion is formed on an inner surface of a first end of the third plate, a second pivot hole is defined in the second pivot portion, a second connecting portion is formed at a second end of the second plate, the second connecting portion comprises two second pins pivotably engaging in the second pivot hole.

12. The electronic device of claim 11, wherein a third pivot portion is formed at a second end of the third plate, the second pivot portion defines a third pivot hole, a third connecting portion is formed at a first end of the fourth plate, the third connecting portion of the fourth plate comprises two third pins pivotably engaging in the third pivot hole.

13. The electronic device of claim 12, wherein a fourth pivot portion is formed on the inner surface of a second end of the first plate, the fourth pivot portion defines a fourth pivot hole, a fourth connecting portion is formed at a second end of the fourth plate, the fourth connecting portion comprises two fourth pins pivotably engaging in the fourth pivot hole.

14. The electronic device of claim 13, wherein an inner wall bounding the fourth pivot hole of the fourth pivot portion of the first plate defines a first positioning slot, and a second positioning slot angled about 90 degrees from the first positioning slot, a first raised portion extends on a circumference of one of the fourth pins of the fourth connecting portion of the fourth plate, the first raised portion of the fourth plate is engaged in either the first positioning slot or the second positioning slot of the first plate.

15. The electronic device of claim 14, wherein an inner wall bounding the second pivot hole of the second pivot portion of the third plate defines a third positioning slot, and a fourth positioning slot angled about 90 degrees from the third positioning slot, a second raised portion extends on a circumference of one of the second pins of the second connecting portion of the second plate, the second raised portion of the second plate is engaged either in the third positioning slot or the fourth positioning slot of the third plate.
